(19) United States
(12) Patent Application Publication
(10) Pub. No.: US 2013/0108740 A1
(43) Pub. Date: May 2, 2013

(54) CONSUMABLES AND METHODS OF PRODUCTION THEREOF

(71) Applicants: Peter Clarke, Berkshire (GB); Sarah Marshall, West Berkshire (GB); Clive Richard Thomas Norton, Chatham, NJ (US)

(72) Inventors: Peter Clarke, Berkshire (GB); Sarah Marshall, West Berkshire (GB); Clive Richard Thomas Norton, Chatham, NJ (US)

(21) Appl. No.: 13/583,358

(22) PCT Filed: Mar. 23, 2011
(86) PCT No.: PCT/GB2011/050586

§ 371 Date: Nov. 15, 2012

(30) Foreign Application Priority Data
Mar. 23, 2010 (GB) 1004895.7
Mar. 23, 2010 (US) 61316486

(51) Int. Cl. A21D 13/00

(52) U.S. Cl. CPC A21D 13/0038
USPC 426/93; 426/496

(57) ABSTRACT

The present invention relates to a consumable biscuit product comprising an extruded biscuit portion, the body portion being formed with one or more channels disposed therein, wherein the one or more channels contain a substance which is different from the substance of the body portion and wherein at least one of the channels does not extend along the full length of the body portion. The present invention also provides a method of production of the same.

### TECHNICAL FIELD OF THE INVENTION

The present invention relates to consumable biscuit products and also to a method of production thereof. In particular, the invention relates to consumable biscuit products comprising at least one channel, wherein the channel may be filled with a substance.

### BACKGROUND TO THE INVENTION

It is desirable to produce consumable biscuit products formed of different components, so as to increase sensory pleasure. Such biscuits are often expensive to produce due to having to assemble the various components into a biscuit product. Secondly, due to the manufacturing process, each component is usually relatively large so that it can be mechanically handled and the process does not lend itself to the introduction of subtle flavours or different formats, other than biscuit sandwiches having a paste filling. It is therefore desirable to provide a consumable biscuit product which is less complicated to produce, whilst having multiple components.

There is also a demand for providing consumable products having a reduced fat or sugar content. It is therefore desirable to provide a consumable biscuit product which can be produced having a lowered fat or sugar content, whilst still maintaining an excellent sensory pleasure.

Further, there is demand for consumable products having improved visual appearance whilst maintaining flavour. It is desirable to provide a consumable biscuit product which is eye-catching whilst still providing a desirable flavour.

Yet further there is demand for consumable products having improved convenience whilst maintaining or improving flavour. It is desirable to provide a consumable biscuit product which increases convenience whilst still maintaining, or even improving, flavour.

It is another desire to provide a consumable biscuit product having an improved or novel sensory experience.

### SUMMARY OF THE INVENTION

According to a first embodiment of the present invention, there is provided a consumable biscuit product comprising an extruded biscuit body portion, the body portion being formed with one or more channels disposed therein, wherein the one or more channels contain a substance which is different from the substance of the body portion and wherein at least one of the channels does not extend along a full length of the body portion.

According to another embodiment of the present invention there is provided a process for manufacturing a consumable biscuit product comprising a body portion having one or more channels disposed therein, the process comprising the step of extruding a biscuit material with one or more channels disposed therein, wherein at least one of the channels contains a substance that is different from the substance of body portion and wherein at least one of the channels does not extend along a full length of the body portion. A yet further aspect of the invention provides an apparatus adapted for producing a consumable biscuit product according to this process.

It should be understood that the term “channel” generally refers to a conduit or space created by an extrusion or other forming process within the body of the product. The channel typically contains matter, and that matter can be in the form of a gas, a liquid, a solid, or a mixture thereof.

A biscuit substance is defined as a substance comprising dough that it cured via heat to form a substantially solid foodstuff. As such it includes substances such as wheat biscuits (such as digestives-type biscuits), oatmeal biscuits, crackers and cake. Preferably the biscuit is a wheat or oatmeal biscuit. Preferably the biscuit is cured (eg cooked) during the extrusion process, i.e. via the heat and/or pressure of extrusion. Preferably the biscuit contains cocoa.

Preferably the channel consists of a substance that belongs to a different food group to the substance of the body portion. Examples of different food groups are

(i) protein rich matter e.g. meats, fish, nuts, beans and dairy products;
(ii) fruit or vegetable matter;
(iii) carbohydrate rich matter such as pasta, rice or bread; and
(iv) sugar/fat rich matter such as any confectionery product, eg chocolate, caramel, cream, etc.

Preferably the channel comprises chocolate or cocoa.

The embodiments of the invention include one or more channels, and the channels can have the same or different shapes. The channels can be capillaries but could alternatively be channels exhibiting a wide variety of cross sectional shapes. The cross-sectional shape of some or all channels may be at least partially frusto-conical, wherein the channels increase or decrease in diameter depending upon which end of the product the channel is viewed from. Alternatively, the one or more channels may have an ‘oscillating’ shape, such that it has alternating sections having narrower diameters followed by sections having wider diameters. This is discussed further hereinbelow.

The consumable product of the present invention has an extended release of any material inserted into the channels, and/or a large voidage (formed by the channels) so as to reduce the amount of biscuit material used in the product, whilst maintaining the overall size of the product. Further the consumable product has a more diverse cross section such that it is more eye catching, and with the convenience of any material inserted into the channels being integral with the consumable product and leakage from the ends of the product minimised.

It should be understood that the term “liquid” is intended to mean that the material is capable of or has a readiness to flow, including gels, pastes and plasticized chocolate. Furthermore, this term is intended to include (but is not limited to) those materials which may be “molten” during extrusion. The skilled addressee will understand that the term “molten” means that the material has been reduced to a liquid form or a form which exhibits the properties of a liquid.

After extrusion, the biscuit body portion may be at least partially or substantially solid, so that it can no longer be considered to flow in a liquid form.

The biscuit material used to produce the body portion may additionally comprise a number of materials commonly used in the production of savoury or sweet biscuits. The biscuits need not be limited to biscuits for human consumption and be destined for consumption of animals (for example, dog chews). A number of materials may be incorporated into the biscuit body portion or the material in the channel(s), for example meat, cereal, cheese, potato, pastry, fruit, spreads or pate. As previously mentioned the body portion is preferably biscuit, but it may additionally or alternatively comprise the abovementioned materials.

Whilst some of the channels may extend along substantially the entire length of the body portion, they may in some embodiments extend no less than 75%, 80%, 90%, 95% or 99% along the length of the body portion (for example, when it is desired to seal the ends of the body portion). If the channels extend along the entire length of body portion, typically the ends of the channels are visible at one or more ends of the body portion.

One or more of the channels may not extend along the length of the body portion. For example, where the body portion comprises a plurality of channels, at least one of the channels may not extend along the length of the body portion. According to one embodiment, up to 25%, up to 50%, up to 75%, or up to 100% of the channels may not extend along the length of the body portion.

One or more of the channels are filled with a material which is different from that of the material used to form the body portion. If two of more channels are provided, different channels may incorporate different materials if desired, and/or any one channel can be filled with different substances along its length. The channels may be filled with a liquid material. The channels may be filled with a material which is solid at a room temperature and fluid at a temperature greater than room temperature. For example, a molten chocolate may be incorporated into the channels and allowed to set when cooled to room temperature. It will be apparent to the skilled addressee that room temperature is commonly regarded as around 20° C. Alternatively, the channels may be filled with a material which is deposited as a liquid and which subsequently solidifies. In such embodiments, the solidification may be dependent or independent of heat. It will be apparent that solidification of a liquid filled channel may be achieved in a number of ways. For example solidification may take place due to one or more of the following:
Cooling—the filling may be molten when deposited which then cools to a solid at room temperature;
Heating—the filling may be liquid when deposited, and the heat of the extruded body portion sets the filling (e.g. pumping egg albumen into a hot extruded body portion will set the egg on contact);
Drying—the filling may be a solution that dries into a solid (e.g. the moisture from the solution is absorbed into the extruded body portion);
Solvent loss—the filling may be in a solvent, whereby the solvent is absorbed into the extruded body portion, leaving a solid;
Chemical reaction—the filling may be deposited as a liquid but reacts or “goes off” into a solid;
Cross-linking—the filling may form a constituents for a cross-linked material due to mixing and/or heating; and
Time—the filling may simply set with time (e.g. a solution of sugars and gelatin will eventually set over time).

If the channels are filled, suitable filling materials for the channels include, but are not limited to, aqueous media, fats, chocolate, caramel, cocoa butter, fondant, syrups, peanut butter, jam, jelly, gels, truffle, praline, chewy candy, hard candy, fruit or vegetable purees, cheese, sauces such as ketchup, custard, cream, medications or any combination or mixture thereof.

If desired, the product may further comprise a coating portion to envelop or enrobe the body portion. The skilled addressee will appreciate that a number of coatings could be employed—for example flour, fat, chocolate, gum, candy, sugar, seeds, nuts etc.

The body portion may be connected to one or more further portions. In some embodiments, the body portion is sandwiched between materials or may be connected or laminated to one or more layers. The further portion or portions may or may not contain inclusions. Suitable inclusions will be readily apparent to the skilled addressee and include a wide range of granular or powdered material, liquid-filled beads and encapsulated materials etc.

In some embodiments, multiple channels are distributed substantially uniformly throughout the biscuit body portion, and may be spaced evenly apart from adjacent channels. In other embodiments, channels may be distributed in pre-defined configurations within the body portion, such as around the periphery of the body portion, or in groups at one or more locations within the body. In some embodiments the body portion has a circular, elliptical, regular polygonal or semi-circular cross-section. The body portion may be shaped in the fowl of a cylinder, a rope, a filament, a strip, a ribbon or the like, or may be shaped in the form of a standard consumable product such a chocolate biscuit, chocolate bar incorporating a biscuitball, stick or ribbon, for example. The exterior of the body portion may be irregular or regular in shape. Furthermore, the body portion may be formed in potentially any shape, for example in the shape of an object, cartoon character or an animal to name a few.

The one or more channels of the invention can have a non-uniform cross section along their length. Suitable examples of such non-uniform cross section include variations in shape and/or area along the channel length. For instance, a channel could exhibit a maximum cross-sectional area that is at least 10% greater than the minimum cross-sectional area of that channel, typically at least 20% greater, more typically at least 50% greater, most typically at least 100% greater.

By way of example of variation of cross-sectional area with length, the channel may be roughly circular in cross section, with a diameter that oscillates from a small to a large diameter along the length of the channel. In the limit, the arrangement would give rise to discrete ‘bubbles’ being present laterally along the length of the consumable product, wherein the ‘bubbles’ are separated by areas fowled of the same material as the biscuit body portion and/or channels having a negligible or no cross-sectional area. The oscillations can be sinusoidal or regularly spaced in any manner, such that all ‘bubbles’ are of equal size, or irregular such that differently sized ‘bubbles’ are created. The ‘bubbles’ can also have non-circular cross sections, such as triangles, squares, ovals, stars, and the like.

If at least part of the diameter of the one or more channels is narrower than the rest, there is significantly reduced scope for the leakage to occur. Indeed, in the embodiments of the invention comprising the ‘bubbles’ channels, or where the narrow part of the channels are on a micrometre scale, the arrangement of the channels and the cutting process can be set up such that the extruded product is cut precisely in the sections of the product where the at least one channel is at it narrowest, thus mitigating premature leakage.

By way of example of variation of shape with length, the cross section of the channel can oscillate, along the length of the channel, between a shape which is oriented vertically and the same shape which is oriented horizontally. Other suitable shapes include rectangles, ovals, stars, etc.

Variations in cross-sectional area with respect to length can be achieved by varying the rate of extrusion of the body portion in relation to the rate of channel formation. For example, if the rate of extrusion of the body portion is slowed, but the rate of channel formation (by virtue of pumping gas or liquid into the extrudate via a die) is maintained or sped up, then a bigger channel cross section will result. Conversely if the rate of extrusion of the body portion is sped up (or maintained), and the rate of channel formation is maintained (or slowed), then a smaller channel cross section will result.

Further variations in cross-sectional area with respect to length can be achieved by extruding the body portion onto a conveyor belt and varying the speed of extrusion relative to the speed of the belt or visa versa.

A range of effects can be formed in the extrudate by rotating the die head whilst extruding onto a planar convenor belt, or rotating the extrudate after extrusion from a static die head, so as to produce channels in the format of swirls or helices.

Variations of shape with length can be obtained by rotating the body portion or the die through which the channel gas/liquid passes, such that the orientation of the channel changes with respect to the body portion.

The die may be equipped with one or a plurality of injector nozzles as desired.

In one embodiment, the channels in the body portion result in a voidage in the range of about 1-99% of the extrudate, or in the range of 5-99% of the extrudate. The voidage may be in the range of about 10-60%, 20-50%, 30-45%, or 35-40%. The voidage may also be in intermediate points in these ranges, for example, about 5-40%, 5-45%, 5-50%, 5-60%, 10-40%, 10 -45%, 10-50%, 10-99%, 20-60%, 20-45%, 20-40%, 20-60%, 20-99%, 30-40%, 30-50%, 30-60% or 30-99%. The voidage may be up to about 99%, 95%, 90%, 80%, 60%, 50%, 45%, 35%, 30%, 20%, 10%, or 5%. The voidage may be over about 5%, 10%, 15%, 20%, 25%, 30%, 35%, 40%, 45%, 50%, 55%, 60%, 65%, 70%, 75%, 80%, 85%, 90% or 95%.

It should be understood that the term “voidage” generally refers to the volume percent of the channel volume relative to the sum of the channels volume and the extruded body portion volume. That is voidage (%)=100×channel volume/(channel volume+extruded body portion volume). In some embodiments, the extruded body portion volume does not include any central region volume created by certain dies, such as an annular die.

The incorporation of channels of a small cross-sectional width or diameter enables the channels in the body portion to be filled with contrasting or complementary consumable materials whilst avoiding the need to incorporate large centre-fill areas which may be prone to leakage through, or out of, the consumable product. The use of a plurality of channels also enables two or more materials to be incorporated into the consumable product to give multiple textures, tastes, colours and/or mouth-feel sensations, throughout the whole consumable product.

It should be understood that the term “plurality” is intended to mean two or more. In some embodiments, a plurality is 3 or more, or 4 or more, or 5 or more, or 6 or more, or 7 or more. There is no particular upper limit on the number associated with “plurality”. In the context of the phrase “plurality of channels”, numbers up to 50 and higher are contemplated.

The channels may be filled by using pump to provide the contrasting or complementary consumable materials.

In some embodiments, the channels have a diameter or width of no more than about 2 mm, 1 mm, 0.5 mm, 0.25 mm, or even less.

Alternatively, wide channels may have a diameter or width of more than 2 mm, more than 5 mm, more than 1 cm, more than 2 cm or even more than 3 cm.

The consumable product may comprise a first extruded portion and a second extruded portion, wherein each portion has a plurality of channels disposed therein, and the channels of the first and second portions are:
a) discontinuous; and/or
b) continuous and oriented in more than one direction.

The channels of each portion may be formed substantially parallel to one another. In one embodiment, the first and second portions are in a stacked configuration, such that the channels of the first and second portions are substantially parallel to each other. In an alternative embodiment, the first and second portions are in a folded configuration. In yet another alternative embodiment, the first and second portions are discontinuous and the channels are oriented in a random configuration in relation to one another. In some embodiments, the channels of the first and/or second portions have a diameter or width of no more than about 3 mm, 2 mm, 1 mm, 0.5 mm, 0.25 mm, or less. It is possible to have channels having a diameter or width as low as about 100 μm 50 μm or 10 μm. The channels of the first and/or second portions may have different widths or diameters.

Alternatively, wide channels may have a diameter or width of more than 2 mm, more than 5 mm, more than 1 mm, more than 2 cm or even more than 3 cm.

There may be further portions in addition to the first and second portions, which may or may not comprise channels. In one embodiment, the consumable product comprises the first portion separated from the second portion by one or more further portions that may or may not contain channels.

According to a further embodiment of the invention, there is provided a consumable biscuit product comprising an extruded body portion having a plurality of channels disposed therein, wherein each channel contains a substance that is different from the substance of the body portion, and is separated from each adjacent channel by a wall formed from the extruded body portion and wherein the wall between each channel has a thickness of no more than the maximum width or diameter of the channel.

The skilled addressee will of course realise that these subsequent embodiments may incorporate features which have already been discussed with reference to the initial embodiment.

As mentioned above, the invention provides a process for manufacturing a consumable biscuit product comprising a body portion, having one or more channels disposed therein, the process comprising the step of:
a) extruding a consumable material with one or more channels disposed therein, wherein the one or more channels contain a substance that is different from the substance of the body portion and wherein at least one of the channels does not extend along a full length of the body portion.

In some embodiments, the process may include an extra step selected from:
b) cutting the extrudate into two or more pieces having a plurality of channels disposed therein and forming a consumable product incorporating the pieces; and/or
c) folding the extrudate and forming a consumable product incorporating the folded extrudate.

Any of the above processes may further comprise the step of depositing a filling in at least part of one or more of the channels. The deposition of the filling may be during the step of extrusion—but could also take place after extrusion. In an embodiment, the filling comprises a fluid. The fluid may comprises a liquid, or a material which is liquid at a temperature greater than room temperature. The fluid may solidify after deposition if desired.

Any of the processes may further comprise the step of quench cooling the extrudate after extrusion. The quench cooling may utilise a fluid, such as air, an oil or liquid nitrogen—but other methods of quench cooling will also be apparent to the skilled addressee.

Any of the processes may further comprise the step of, immediately after extrusion, stretching or rotating the extrudate. Stretching or rotating the extrudate may be undertaken by a number of means, for example passing the extrudate over, or through conveyor belts or rollers operating at different speeds, so as to stretch the extrudate. By employing this additional step, extrusions having channels of a larger diameter can be undertaken, which can be reduced in diameter gradually over time so as to produce an extrudate with smaller channels which would have been more difficult to produce. Commonly, channels having a bore size of about 2 mm or more will be produced during extrusion and these channels will be reduced significantly by stretching the extrudate.

Any of the processes may further comprise the step of enveloping the consumable product in a coating Such a coating will be apparent to the skilled addressee and was discussed previously hereinabove.

The extrudable consumable biscuit material will at least partially or substantially solidify after extrusion. This is as a result of the temperature and pressure required to perform the extrusion step, but may also be supplemented by an additional cooking or curing step. Preferably, the biscuit material is heated to a temperature of 180° C. during extrusion, such that the dough is at least partially cooked and preferably ready for consumption after exiting from the die. Alternatively lower temperatures can be used in combination with increased pressures of for example Around 100 kPa, although any pressure above atmospheric pressure will assist in the cooking action. If the dough is not cooked, or is only partially cooked during extrusion, the biscuit may be passed through an oven after extrusion to cook the dough.

The processes may be used for producing a consumable product as herein above described.

As mentioned above, the invention also provides apparatus which is adapted for producing a consumable product according to the processes as herein above described. WO 2005/056272 discloses an apparatus for producing an extruded product including a plurality of channels. WO 2008/044122 discloses a related apparatus, which additionally includes means for quench cooling an extrudate as it exits the die. Both of these apparatus may be employed/adapted for use in producing the consumable product in accordance with the present invention.

### DETAILED DESCRIPTION OF THE INVENTION AND EXAMPLES

Specific examples of the present invention will now be described, by way of illustration only, with reference to the accompanying drawings, in which:

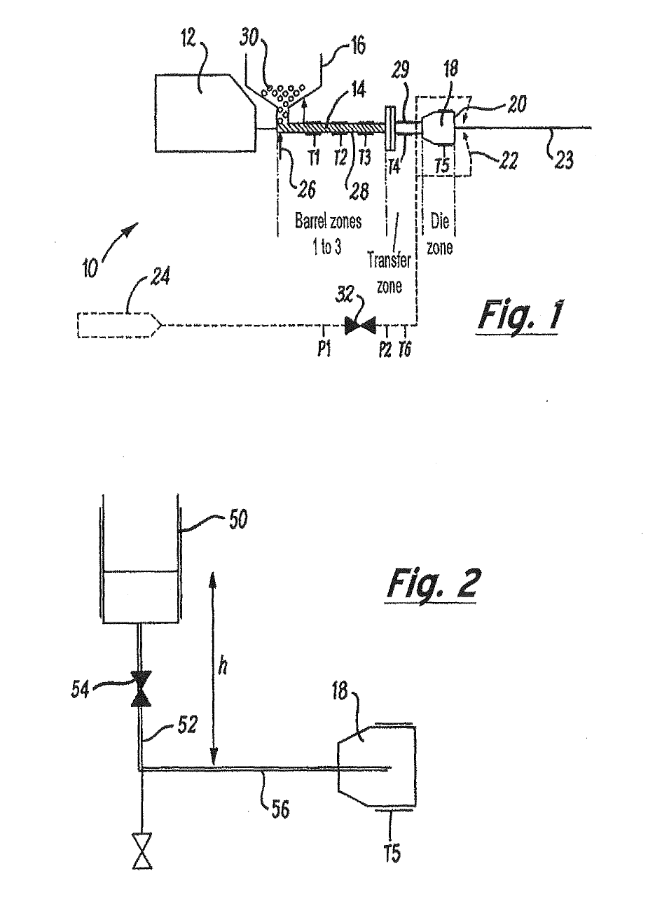

FIG. 1 is a schematic diagram illustrating the overall apparatus used in accordance with the present invention;

FIG. 2 is a schematic diagram illustrating the apparatus which can be used in conjunction with the apparatus shown in FIG. 1, so as to provide liquid filled channels;

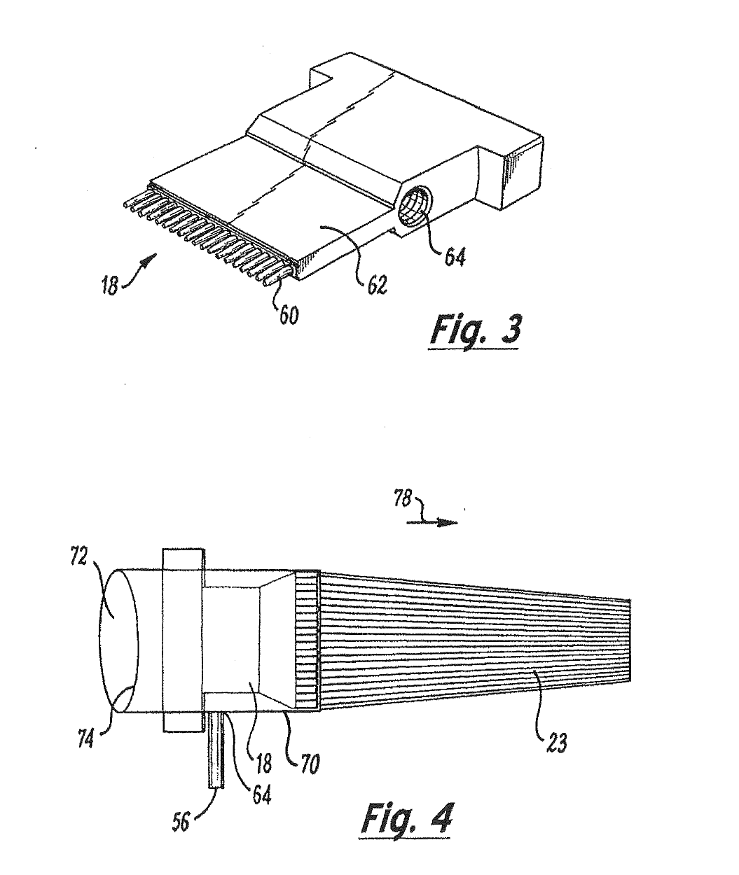

FIG. 3 is a photograph of the extrusion die used to fowl channels in the extruded material of the Example of FIG. 1;

FIG. 4 is a plan view of the extrusion die which incorporates the extrusion die shown in FIG. 3 in the apparatus as illustrated in FIGS. 1 and 2;

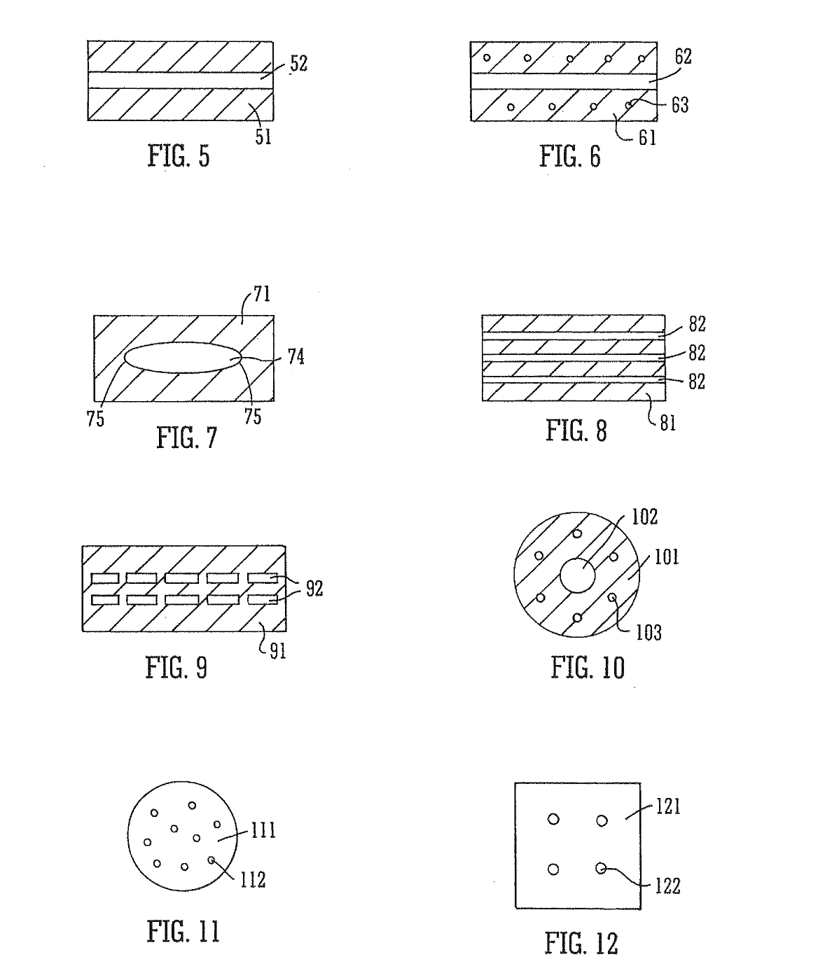

FIGS. 5 to 12 show cross sections though a variety of consumable biscuit products according to the present invention. All cross sections are cross sections taken parallel to the largest exterior flat surface.

Experiments were conducted to produce a variety of biscuits incorporating channels. Two phases of extrusion work were undertaken using various materials. The first phase concerned the extrusion of biscuit using a capillary die attached to a small-scale extruder in a non-food grade environment for creating biscuit extrudates with channels running therethrough in both low- and high-voidage focus. The second phase of the experimental work built upon the first phase to produce low and high voidage biscuit extrudates containing an array of cocoa-butter filled channels. The first and second phases are described in the below Example.

Phase one concerned the extrusion of biscuit using a capillary die attached to a small-scale extruder, in order to confirm that biscuit having channels could be formed in accordance with the present invention.

The materials that were trialled during this investigation are shown in Table 1.

TABLE 1
Materials tested.

| Material number | Majority ingredients | Application |
|---|---|---|
| 1 | Digestive biscuit mix | Extruded matrix |
| 2 | Cracker mix | Extruded matrix |
| 3 | Cocoa butter | Channel filler |

Materials 1 and 2 were supplied as large solid blocks. All materials were crushed prior to extrusion to yield a fine granular powder, with grain sizes ranging between 1 mm and 5 mm. Material 3 was supplied as a tub of solidified cocoa butter; the required quantity was broken up into a fine powder containing only small lumps before being fed into the heated cocoa butter reservoir.

The extrusion equipment consisted of a Betol single screw extruder, with a screw diameter of approximately 12 mm, and a screw L/D ratio of roughly 22.5:1. The extruder had four different temperature zones (denoted T1-T4 in FIG. 1 as described later), each of which could be independently controlled using ND controllers connected to band heaters. The Mk 3 MCF extrusion die, containing an entrainment array consisting of 17 hypodermic needles, was connected on the extruder endplate. Two opposed air jets, used to rapidly quench the extrudate emerging from the extrusion die, were placed above and below the die exit; these jets were connected via a valve to a compressed air line at 6 Barg. A schematic diagram showing the general layout of the extrusion line is shown in FIG. 1 and a schematic drawing of the capillary die is shown in FIG. 2.

With reference to FIG. 1, there is shown a schematic diagram of the extrusion apparatus 10 used in the experiments. The apparatus briefly comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed towards the die outlet 20 so as to cool the extruded material 23 which is produced and these jets are fed with compressed air 24. If desired, the area of the apparatus where the hopper 16 is coupled to the screw 14 can be cooled by means of a cooling feed 26. Surrounding the screw 14 is a barrel 28 which is formed having three barrel temperature zones denoted T1 to T3—the temperatures of each zone being capable of being controlled. The barrel 28 is connected to the die 18 by means of a feed conduit 29 which also has a temperature zone T4 which can be controlled.

In use, the hopper 16 is filled with material 30 (such as biscuit dough) which can be heated so as to render it (or maintain it as) a liquid (not solid or solid particulate form). Before the material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature is adjusted again (if required) by temperature control T4 before entering the die 18. The die 18 has a number of needles (not shown) located within an entrainment body so that the material passes over and around the needles. At the same time that the material is being extruded, compressed air 24 is forced through the needles so that the extrudate contains a number of channels. The air can be pulsed on and off to make channels which actually comprise a line of discrete bubbles, or the air pressure can simply be altered to give rise to continuous channels having a varying cross-sectional area along their length, from having a relatively wide diameter (for example, almost as wide as the body portion of the product itself) to extremely narrow (for example, on the micrometer scale). Similar effects can be achieved by rotating the die(s) and/or the extrudate to ‘nip’ the channels and thus produce ‘bubbles’, and by adjusting the rate of flow of the extrudate. The extrudate 23 is heated by means of the jets 22 as it is released from the die 18, in order to cook the extrudate. A valve 32 controls the flow of compressed air to the apparatus and pressure devices P1 and P2 control the pressure of the compressed air 24 before and after the valve. The compressed air line also has a temperature control T6 so as to control the temperature of the air before entering the die.

With reference to FIG. 2, there is shown an adaptation of the apparatus shown in FIG. 1. Rather than compressed air 24 being forced through needles, the needles are connected to a reservoir 50 containing cocoa butter. The reservoir 50 is heated so that the cocoa butter is maintained at the correct temperature so as to maintain it in a liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having number of needles, so that when the material is being extruded, the channels fowled around and the needles can be simultaneously filled with cocoa butter. Of course, the channels could be filled with other types of liquid material if desired. If a line of discrete bubbles is required, the flow of cocoa butter is pulsated on and off. Again similar effects can be achieved by rotating the die(s) and/or the extrudate to ‘nip’ the channels and produce bubbles, and by adjusting the rate of flow of the extrudate.

FIG. 3 shows a die 18 in more detail. In particular, this figure shows that the metallic die 18 has, at one end, a plurality of needles 60 which are joined to a cavity 62 which is in fluid communication with an inlet channel 64 for pumping a fluid material into the channels of the extrudate.

With reference to FIG. 4, there is shown the die 18 in place in an entrainment body 70. Molten material 72 enters an opening 74 of the entrainment body 70 and the material is forced over and around the needles 60 of the die 18. At the same time, either air or liquid cocoa butter enters the die inlet by means of a fluid feed conduit 56. When operational, the molten material is extruded through the entrainment body 70 over the needles 60 of the die 18. Either air or cocoa butter is then pumped through the needles at the same time so as to produce an extrudate 23 (in direction 78) which either has channels with no filling or channels filled with cocoa butter. These channels can have varying cross-sectional area along their length (not shown), which is achieved by adjusting flow rates and/or use of rotation as discussed above.

The teachings of these proof of principle experiments could be applied to extruding a biscuit dough having at least one centre filled channel.

Looking now at FIG. 5, this shows a consumable product according to the present invention comprising a biscuit body portion 51 containing a caramel filling 52 which fills a channel in the biscuit body portion 51. The biscuit is formed by extruding the body portion 11 through a rectangular die, with cooking occurring during the extrusion process, and the caramel filling being simultaneously extruded through a centrally sited small circular nozzle. The caramel filling provides an increased interest to the biscuit consumer.

FIG. 6 shows a biscuit similar to that shown in FIG. 5, wherein the biscuit body potion 61 comprises a caramel filling 62 and bubbles of syrup 63 which are produced. The biscuit is made in the same manner as the biscuit of FIG. 5, with the additional presence of two nozzles for extrusion of the syrup 63. The syrup supply is turned on and off to produce the small bubbles within the dough, and these bubbles provide added consumer interest whilst at the same time minimising the amount of syrup being used in manufacture.

FIG. 7 shows a biscuit body portion 71 in combination with an elongate bubble of ice cream 74 that fills a channel. The channel has been nipped at both ends 75 by either twisting the nozzle or stopping the flow of ice cream. Having the ice cream fully encapsulated by the body portion 71 prevents the ice cream from dripping out of the biscuit body portion if the ice cream melts prior to consumption, which keeps the product looking good and prevents leakage and therefore makes it more appealing to consumers.

FIG. 8 shows a biscuit cracker body portion 81 with three cheese filled channels 82 running therethrough. The cheese filled channels are all of the same width and are equally spaced from one another, although alternatively they can be of different widths or spaced in another fashion. The cracker is produced in the same manner as the biscuit of FIG. 5, and the presence of cheese inside the cracker provides a highly convenient ‘cheese and crackers’ food for consumers.

FIG. 9 shows a biscuit cracker body portion 91 with two pate filled channels 92. The channels 92 are discontinuous, and have been formed by temporarily stopping the flow of pate and then restarting it again. As with the cheese cracker of FIG. 8, this cracker provides added convenience to the consumer, and also minimises the amount of pate used in order to save costs.

FIG. 10 shows a ring shaped biscuit body portion 101 containing chocolate channels 103 within the body portion itself, and a truffle channel 102 which runs down central void of the ring shaped body portion 101. Alternatively the truffle channel 102 could be replaced with an empty void. This ring shaped biscuit is made by extruding the body portion and channels as in previous examples, and then cutting the resulting extruded cylinder of product into slices, wherein each slice produces one ring shaped biscuit. Such ring shaped biscuits are of visual interest to consumers since the products filling the channels are easily visible to consumers.

FIG. 11 shows a digestive biscuit body portion 111 containing a random distribution of chocolate filled channels 112. The process of manufacturing the digestive biscuit is similar to the process used to produce the product of FIG. 10, i.e. the body portion and channels are extruded, and then the tubular product is sliced to produce individual biscuits. The biscuit of FIG. 11 is advantageous over prior art chocolate digestive biscuits since it can be dipped in tea or other hot drinks, without the chocolate melting all over the consumer's hands.

FIG. 12 shows a square dog biscuit body portion 121 comprising four evenly spaced channels 122 which contain a tooth cleaning/refreshing agent. The biscuit is made in the same manner as the biscuits of FIGS. 10 and 11, and has the advantage that the cleaning/refreshing agent is clearly visible to the purchaser, and thus the purchaser is more aware of the dual purpose of the biscuit—pleasure for the dog and also cleaning of the dog's teeth.

Although the body portion and channels may be depicted as uniform in shape and pattern in some embodiments described herein, it should be understood that the body portion and/or the channels may be non-uniform in some embodiments. There may be variations in the overall dimensions of the product, such as, for instance, the dimensions of the body portion, the channels, the wall thicknesses between each channel and the outer wall thickness of the product. For example, in some embodiments, the mechanical process of extrusion and optional further manipulation of the extrudate, such as stretching, may create non-uniformities in the dimensions of the product. Such processes also may create random variations in the positioning of the channels. The channels accordingly may be irregularly positioned in some embodiments. In addition, the channels may be symmetrically disposed in the body portion or asymmetrically disposed in the body portion. In some embodiments, one group of channels may be symmetrically disposed and another group of channels may be asymmetrically disposed in the body portion.

The invention is not restricted to the details of the foregoing embodiments, and many other embodiments will be apparent to the skilled addressee.

1. A consumable biscuit product comprising an extruded biscuit body portion, the body portion being formed with one or more channels disposed therein, wherein the one or more channels contain a substance which is different from the substance of the body portion material and wherein at least one of the channels does not extend along a full length of the body portion.

2. A consumable biscuit product according to claim 1, wherein the body portion comprises a plurality of channels.

3. A consumable biscuit product according to claim 2, wherein different materials are provided in different channels.

4. A consumable biscuit product according to claim 2 comprising at least two channels, wherein one channel has a diameter of less than 5 mm, and another channel has a diameter of greater than 1 cm.

5. A consumable biscuit product according to claim 1, wherein the at least one channel is discontinuous.

6. A consumable biscuit product according to claim 1, wherein the biscuit is a confectionery product.

7. A consumable biscuit product according to claim 1, wherein the biscuit is a savoury product.

8. A consumable biscuit product according to claim 1, wherein the biscuit is a pet product.

9. A process for manufacturing a consumable biscuit product comprising a body portion having one or more channels disposed therein, the process comprising the step of:
a) extruding an extrudable consumable material to form a body portion with one or more channels disposed therein, wherein the one or more channels contain a substance different from that of the body portion and wherein at least one of the channels does not extend along a full length of the body portion.

10. A process according to claim 9, wherein the extrudable consumable material comprises wheat biscuit, oatmeal biscuit or cracker.

11. A process as claimed in claim 9, wherein the substance in the channel is deposited during the step of extrusion.

12. A process as claimed in claim 9, wherein the biscuit is at least partially cooked during extrusion.

13. A process as claimed in claim 9, wherein the biscuit is at least partially cooked after extrusion.

14-16. (canceled)
